(19) United States
(12) Patent Application Publication
(10) Pub. No.: US 2026/0188906 A1
(43) Pub. Date: Jul. 2, 2026

(54) MULTI-FEED ANTENNA

(71) Applicant: Industrial Technology Research Institute, Hsinchu (TW)

(72) Inventors: Kin-Lu Wong, Kaohsiung City (TW); Wei-Yu Li, Hsinchu City (TW); Wei Chung, Hsinchu County (TW)

(73) Assignee: Industrial Technology Research Institute, Hsinchu (TW)

(21) Appl. No.: 19/059,265

(22) Filed: Feb. 21, 2025

(30) Foreign Application Priority Data
Dec. 31, 2024 (TW) 113151722

(51) Int. Cl. H01Q 9/04

(52) U.S. Cl. CPC H01Q 9/045; H01Q 9/0414

(57) ABSTRACT

The disclosure provides a multi-feed antenna including first and second conductor layers and slit structures. The first and second conductor layers are spaced apart at a first interval. The second conductor layer has a center slot structure. The slit structures are all formed at the second conductor layer, wherein each has a first end connecting with the center slot structure and a second end respectively extending to different side edges of the second conductor layer. The slit structures make the second conductor layer form radiating conductor plates. A total number of the slit structures equals to a total number of the radiating conductor plates. Each radiating conductor plate is electrically connected or electrically coupled to at least one signal source. Each signal source respectively excites the second conductor layer to generate at least one resonant mode. The plurality of resonant modes cover at least one identical first communication band.

### CROSS-REFERENCE TO RELATED APPLICATION

This application claims the priority benefit of Taiwan application serial no. 113151722, filed on Dec. 31, 2024. The entirety of the above-mentioned patent application is hereby incorporated by reference herein and made a part of this specification.

### TECHNICAL FIELD

The technical field to which the disclosure belongs is related to a multi-feed antenna design, and more particularly to a multi-feed antenna architecture capable of achieving high integration.

### BACKGROUND

Practical application requirements of the continuous improvement of wireless communication quality and data transmission rate have led to the rapid development of multi-input multi-output (MIMO) multi-antenna arrays, variable-pattern multi-antenna array architectures, and high-gain multi-antenna arrays. Therefore, multi-antenna design having the advantage of conjoined integration has become one of the popular research topics.

Multi-antenna integrated arrays have the potential to improve communication spectrum efficiency, increase wireless channel capacity, and thus have the potential to enhance the reception signal reliability and the data transmission rate (throughput) of communication systems. When a plurality of antennas operating in the identical frequency band are integrated into an antenna array, the issue of mutual coupling interference may occur, resulting in worse isolation between the plurality of antenna feed ports. As a result, radiation characteristics and antenna efficiency are degraded. This results in a decrease in the speed of wireless communication data transmission and increases the difficulty of implementing multi-antenna integration.

Some prior art has proposed a design method of designing a resonant structure on the ground between a plurality of antennas as a coupling energy isolator to improve the energy isolation between a plurality of antennas. However, such a design method may lead to the excitation of additional coupling current, resulting in an increase in the correlation coefficient between a plurality of antennas and a reduction in communication transmission efficiency, and may also increase the overall size of the multi-antenna array, causing process instability, thus leading to higher mass production costs. Therefore, the design method above is not easy to be widely implemented in various communication equipment or devices. Therefore, how to successfully design a multi-feed antenna array having the advantage of conjoined integration and simultaneously achieve the advantages of good matching and good radiation characteristics is a technical challenge that is not easy to overcome.

Therefore, a multi-feed antenna design method that may solve the above issues is needed to meet the practical application requirements of future high data transmission communication devices or equipment.

### SUMMARY

Accordingly, an embodiment of the disclosure discloses a multi-feed antenna. Some implementation examples according to the examples may solve the above technical issues.

According to an exemplary embodiment, the disclosure provides a multi-feed antenna. The multi-feed antenna includes a first conductor layer, a second conductor layer, and a plurality of slit structures. The second conductor layer is spaced apart from the first conductor layer at a first interval. The second conductor layer has a center slot structure. The plurality of slit structures are all formed at the second conductor layer, wherein each has a first end connecting with the center slot structure, and each has a second end respectively extending to different side edges of the second conductor layer. The plurality of slit structures make the second conductor layer form a plurality of radiating conductor plates. A total number of the slit structures equals to a total number of the radiating conductor plates. Each of the radiating conductor plates is electrically connected or electrically coupled to at least one signal source. Each of the signal sources respectively excites the second conductor layer to generate at least one resonant mode. The plurality of resonant modes cover at least one identical first communication band.

In order to have a better understanding of the above and other contents of the present application, the following embodiments are specifically cited and described in detail with reference to the accompanying drawings.

### BRIEF DESCRIPTION OF THE DRAWINGS

FIG. 1A is a structural diagram of a multi-feed antenna 1 of an embodiment of the disclosure.

FIG. 1B is a return loss curve diagram of the multi-feed antenna 1 of an embodiment of the disclosure.

FIG. 1C is a graph of an isolation curve of the multi-feed antenna 1 of an embodiment of the disclosure.

FIG. 1D is a graph of the radiation efficiency of the multi-feed antenna 1 of an embodiment of the disclosure.

FIG. 2A is a structural diagram of a multi-feed antenna 2 of an embodiment of the disclosure.

FIG. 2B-1 is a return loss curve diagram of the multi-feed antenna 2 of an embodiment of the disclosure.

FIG. 2B-2 is a return loss curve diagram of the multi-feed antenna 2 of an embodiment of the disclosure.

FIG. 2C-1 is a graph of an isolation curve of the multi-feed antenna 2 of an embodiment of the disclosure.

FIG. 2C-2 is a graph of an isolation curve of the multi-feed antenna 2 of an embodiment of the disclosure.

FIG. 2D-1 is a graph of the radiation efficiency of the multi-feed antenna 2 of an embodiment of the disclosure.

FIG. 2D-2 is a graph of the radiation efficiency of the multi-feed antenna 2 of an embodiment of the disclosure.

FIG. 3A is a structural diagram of a multi-feed antenna 3 of an embodiment of the disclosure.

FIG. 3B-1 is a return loss curve diagram of the multi-feed antenna 3 of an embodiment of the disclosure.

FIG. 3B-2 is a return loss curve diagram of the multi-feed antenna 3 of an embodiment of the disclosure.

FIG. 3C-1 is a graph of an isolation curve of the multi-feed antenna 3 of an embodiment of the disclosure.

FIG. 3C-2 is a graph of an isolation curve of the multi-feed antenna 3 of an embodiment of the disclosure.

FIG. 3D-1 is a graph of the radiation efficiency of the multi-feed antenna 3 of an embodiment of the disclosure.

FIG. 3D-2 is a graph of the radiation efficiency of the multi-feed antenna 3 of an embodiment of the disclosure.

FIG. 4 is a structural diagram of a multi-feed antenna 4 of an embodiment of the disclosure.

### DETAILED DESCRIPTION OF DISCLOSED EMBODIMENTS

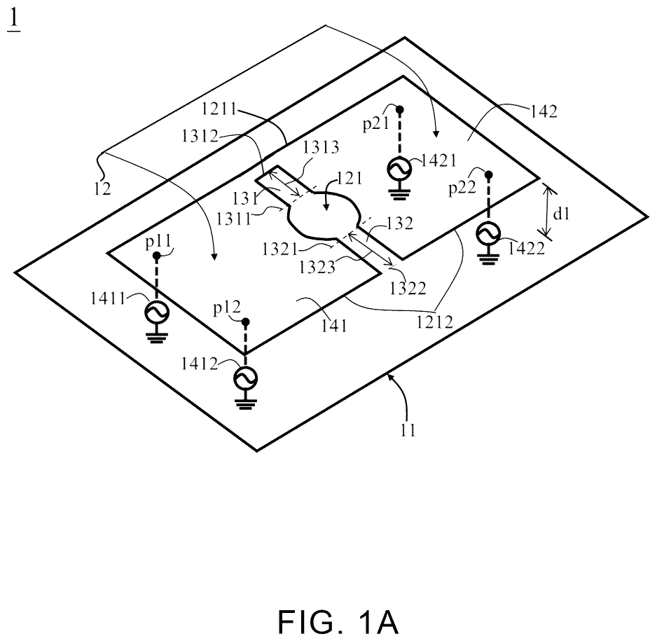

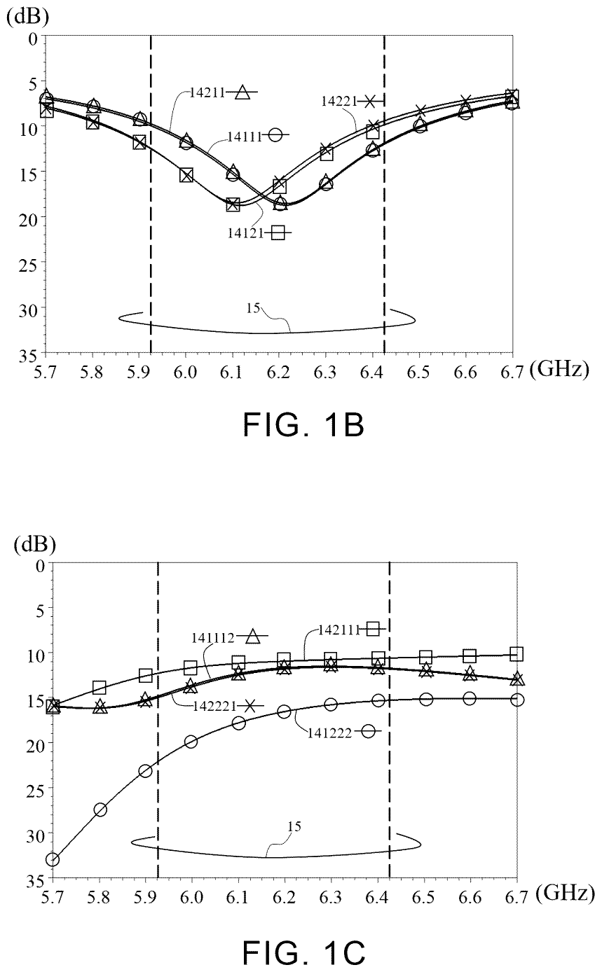

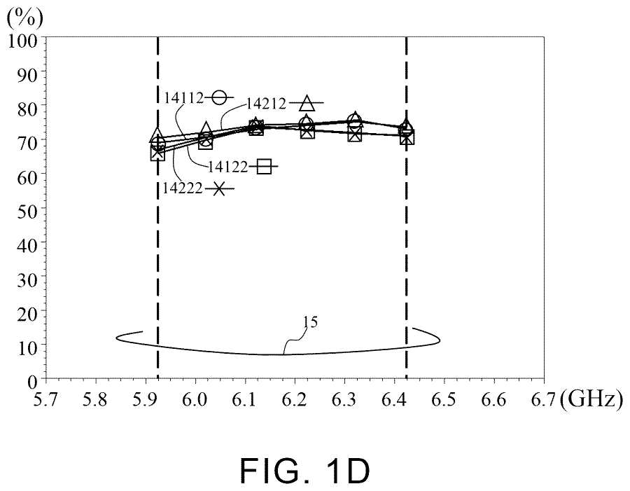

FIG. 1A is a structural diagram of a multi-feed antenna 1 of an embodiment of the disclosure. As shown in FIG. 1A, the multi-feed antenna 1 includes a first conductor layer 11, a second conductor layer 12, and a plurality of slit structures 131 and 132. The second conductor layer 12 is spaced apart from the first conductor layer 11 at a first interval d1. The second conductor layer 12 has a center slot structure 121. The plurality of slit structures 131 and 132 are all formed at the second conductor layer 12, wherein each has first ends 1311 and 1321 connecting with the center slot structure 121, and each has second ends 1312 and 1322 respectively extending to different side edges 1211 and 1212 of the second conductor layer 12. The plurality of slit structures 131 and 132 make the second conductor layer 12 form a plurality of radiating conductor plates 141 and 142. The total number of the slit structures 131 and 132 equals to the total number of the radiating conductor plates 141 and 142, both of which are two. Each of the radiating conductor plates 141 and 142 is respectively and electrically connecting with two signal sources 1411 and 1412, 1421 and 1422. The signal sources 1411 and 1412, 1421 and 1422 each respectively have an electrical connection point p11, p12, p21, p22 on different radiating conductor plates 141 and 142. Each of the signal sources 1411 and 1412, 1421 and 1422 respectively excites the second conductor layer 12 to generate at least one resonant mode 14111 and 14121, 14211 and 14221 (as shown in FIG. 1B). The plurality of resonant modes 14111 and 14121, 14211 and 14221 cover at least one identical first communication band 15 (as shown in FIG. 1B).

In particular, each of the radiating conductor plates 141 and 142 is electrically connecting with two signal sources 1411 and 1412, 1421 and 1422. The second end 1322 of the slit structure 132 is an open end, and the second end 1312 of the slit structure 131 is a closed end. There are slit lengths 1313 and 1323 from the first ends 1311 and 1321 to the respective second ends 1312 and 1322 of the slit structures 131 and 132, respectively. The distance of the slit lengths 1313 and 1323 is between 0.1 wavelengths and 0.49 wavelengths of the lowest operating frequency of the first communication band 15 (as shown in FIGS. 1B, 5.925 GHz to 6.425 GHz). The distance of a first interval d1 is between 0.01 wavelengths and 0.336 wavelengths of the lowest operating frequency of the first communication band 15. The area of the second conductor layer 12 is between 0.25 wavelengths squared and 0.99 wavelengths squared of the lowest operating frequency of the first communication band 15. The area of the center slot structure 121 is between 0.01 times and 0.39 times the area of the second conductor layer 21. The total number of the slit structures 131 and 132 is two, the total number of the slit structures is an even number, and the total number of the slit structures is less than or equal to 6. The signal sources 1411 and 1412, 1421 and 1422 are transmission lines, impedance matching circuits, amplifier circuits, feeding networks, switch circuits, connector elements, filter circuits, integrated circuit chips, or RF front-end modules. In practical applications, the multi-feed antenna 1 may be manufactured and assembled using, but not limited to, a circuit board process, a conductor cutting process, a ceramic process, a plastic injection molding process, or a plastic metallization process. The multi-feed antenna 1 may be configured as a single set or configured as multiple sets and applied to a multi-input multi-output antenna system, a field-switching antenna system, or a beam-forming antenna system, or electrically connected via a transmission line or a radio-frequency feeding network to improve radiation gain.

FIG. 1A is the multi-feed antenna 1 of an embodiment of the disclosure. The second conductor layer 12 is designed to have the center slot structure 121 to effectively achieve good isolation between the four signal sources 1411 and 1412, 1421 and 1422 (as shown in FIG. 1C) to increase the radiation efficiency of the excited resonant modes 14111 and 14121, 14211 and 14221 in the covered first communication band 15 (as shown in FIG. 1D). The multi-feed antenna 1 is designed such that a plurality of slit structures 131 and 132 are all formed at the second conductor layer 12, the plurality of slit structures 131 and 132 each have first ends 1311 and 1321 connecting with the center slot structure 121, and each have second ends 1312 and 1322 respectively extending to different side edges 1211 and 1212 of the second conductor layer 12. Therefore, the impedance matching between the two radiating conductor plates 141 and 142 and the four signal sources 1411 and 1412, 1421 and 1422 may be effectively improved (as shown in FIG. 1B). Furthermore, by designing the distance of the slit lengths 1313 and 1323 to be between 0.1 wavelengths and 0.49 wavelengths of the lowest operating frequency of the first communication band 15 (as shown in FIGS. 1B, 5.925 GHz to 6.425 GHz), the distance of the first interval d1 is between 0.01 wavelengths and 0.336 wavelengths of the lowest operating frequency of the first communication band 15, the area of the second conductor layer 12 is between 0.25 wavelengths squared and 0.99 wavelengths squared of the lowest operating frequency of the first communication band 15, and the area of the center slot structure 121 is designed to be between 0.01 times and 0.39 times the area of the second conductor layer 12 to effectively optimize the structural dimensions of the multi-feed antenna 1 conjoined integration and increase the operating bandwidths of the resonant modes 14111 and 14121, 14211 and 14221 excited by the four signal sources 1411 and 1412, 1421 and 1422 at the same time (as shown in FIG. 1B). Therefore, the multi-feed antenna 1 of an embodiment of the disclosure may successfully achieve the technical effects of multi-antenna compatible conjoined integration, broadband operation, and good radiation efficiency.

FIG. 1B shows a return loss curve diagram of the multi-feed antenna 1 of an embodiment of the disclosure. The following sizes are selected for the experiment: the first interval d1 is approximately 3.5 mm; the distances of the slit lengths 1313 and 1323 are approximately 12.8 mm and 13.3 mm respectively; the area of the second conductor layer 12 is approximately 487 mm²; and the area of the center slot structure 121 is approximately 2.25mm². As shown in FIG. 1B, the four signal sources 1411 and 1412, 1421 and 1422 could effectively excite the second conductor layer 12 to respectively generate at least one well-matched resonant mode 14111 and 14121, 14211 and 14221 (as shown in FIG. 1B), and cover at least one identical first communication band 15 (as shown in FIGS. 1B, 5.925 GHz to 6.425 GHz). In the present embodiment, the frequency band range of the first communication band 15 is 5.925 GHz to 6.425 GHz, and the lowest operating frequency of the first communication band 15 is 5.925 GHz. FIG. 1C is a graph of an isolation curve of the multi-feed antenna 1 of an embodiment of the disclosure. The isolation curve between the signal source 1411 and the signal source 1412 is 141112, the isolation curve between the signal source 1412 and the signal source 1422 is 141222, the isolation curve between the signal source 1422 and the signal source 1421 is 142221, and the isolation curve between the signal source 1421 and the signal source 1411 is 142111. As shown in FIG. 1C, good isolation could be achieved between all of the four signal sources 1411 and 1412, 1421 and 1422 of the multi-feed antenna 1. FIG. 1D shows a graph of the radiation efficiency of the multi-feed antenna 1. The radiation efficiency curve of the signal source 1411 is 14112, the radiation efficiency curve of the signal source 1412 is 14122, the radiation efficiency curve of the signal source 1421 is 14212, and the radiation efficiency curve of the signal source 1422 is 14222. As shown in FIG. 1D, the four signal sources 1411, 1412 and 1421, 1422 could all achieve good radiation efficiency characteristics within the operating frequency band of the first communication band 15.

The communication band operations and the experimental data covered in FIG. 1B, FIG. 1C, and FIG. 1D are for experimentally proving the technical efficacy of the multi-feed antenna 1 of an embodiment of the disclosure in FIG. 1A and are not intended to limit the communication band operations, the applications, and the specifications that may be covered by the practical application of the multi-feed antenna 1 of the disclosure. The multi-feed antenna 1 may be configured as a single set or configured as multiple sets and applied to a multi-input multi-output antenna system, a pattern switching antenna system, or a beam-forming antenna system, or electrically connected with a transmission line or a radio-frequency feeding network to improve radiation gain.

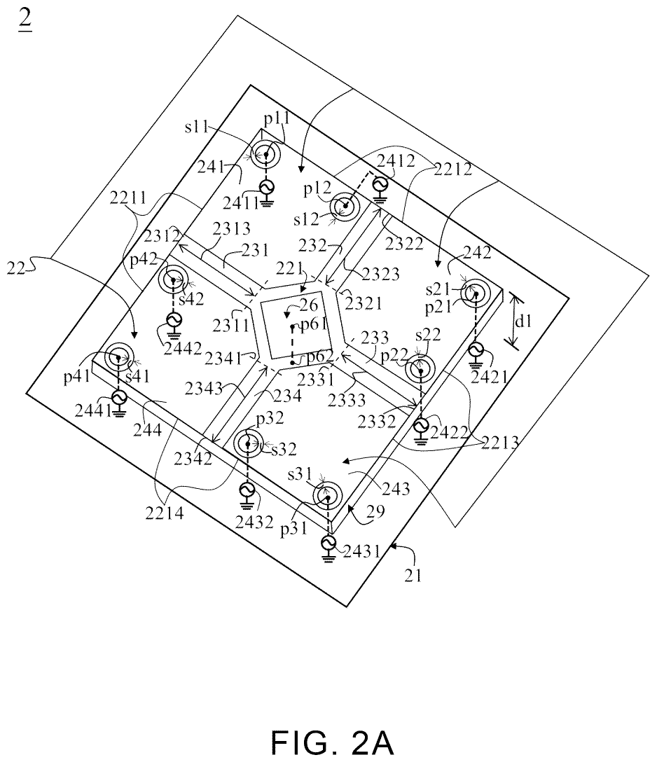

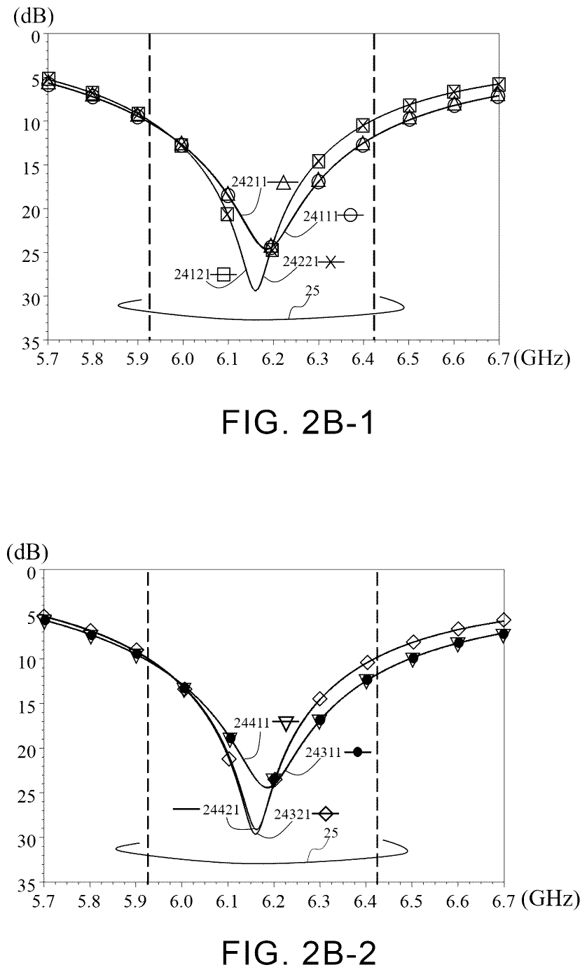

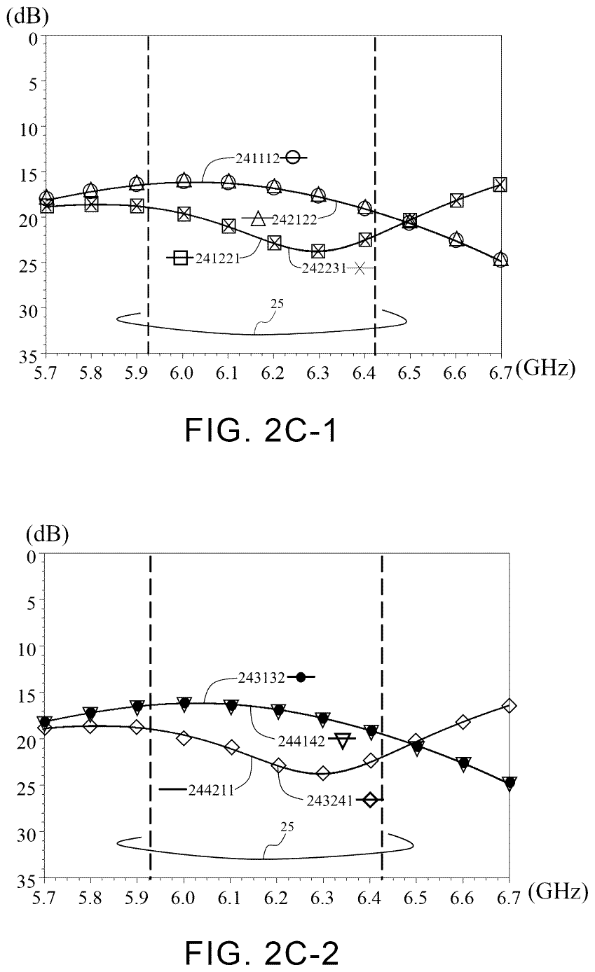

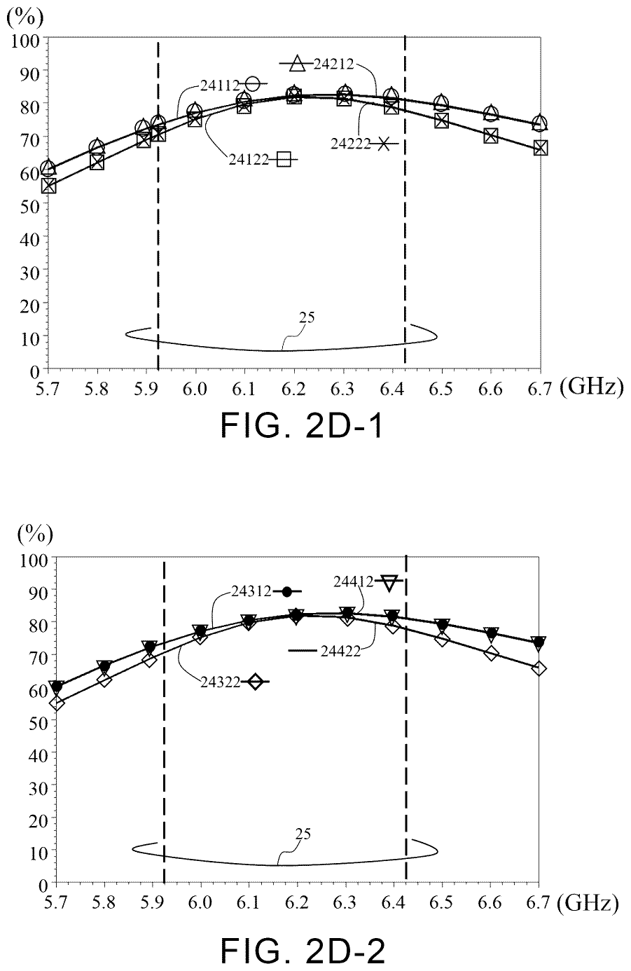

FIG. 2A is a structural diagram of a multi-feed antenna 2 of an embodiment of the disclosure. As shown in FIG. 2A, the multi-feed antenna 2 includes a first conductor layer 21, a second conductor layer 22, and a plurality of slit structures 231, 232, 233, 234. There is a first interval d1 between the second conductor layer 22 and the first conductor layer 21. The second conductor layer 22 has a center slot structure 221. The plurality of slit structures 231, 232, 233, 234 are all formed at the second conductor layer 22, wherein each has first ends 2311, 2321, 2331, 2341 connecting with the center slot structure 221, and each has second ends 2312, 2322, 2332, 2342 respectively extending to different side edges 2211, 2212, 2213, 2214 of the second conductor layer 22. The plurality of slit structures 231, 232, 233, 234 make the second conductor layer 22 form a plurality of radiating conductor plates 241, 242, 243, 244. The total number of the slit structures 231, 232, 233, 234 equals to the total number of the radiating conductor plates 241, 242, 243, 244, which is four. Each of the radiating conductor plates 241, 242, 243, 244 is electrically coupled to two signal sources 2411 and 2412, 2421 and 2422, 2431 and 2432, 2441 and 2442. There are coupling intervals s11 and s12 and electrical connection points p11 and p12 between the signal sources 2411 and 2412 and the radiating conductor plate 241, respectively. There are coupling intervals s21 and s22 and electrical connection points p21 and p22 between the signal sources 2421 and 2422 and the radiating conductor plate 242, respectively. There are coupling intervals s31 and s32 and electrical connection points p31 and p32 between the signal sources 2431 and 2432 and the radiating conductor plate 243, respectively. There are coupling intervals s41 and s42 and electrical connection points p41 and p42 between the signal sources 2441 and 2442 and the radiating conductor plate 244, respectively. Each of the signal sources 2411, 2412, 2421, 2422 and 2431, 2432, 2441, 2442 respectively excites the second conductor layer 22 to generate at least one resonant mode 24111, 24121, 24211, 24221 (as shown in FIG. 2B-1) and 24311, 24321, 24411, 24421 (as shown in FIG. 2B-2). The plurality of resonant modes 24111, 24121, 24211, 24221 and 24311, 24321, 24411, 24421 cover at least one identical first communication band 25 (as shown in FIG. 2B-1 and FIG. 2B-2).

In particular, each of the radiating conductor plates 241, 242, 243, 244 is electrically coupled to two signal sources 2411 and 2412, 2421 and 2422, 2431 and 2432, 2441 and 2442, respectively. The second ends 2312, 2322, 2332, 2342 of the plurality of slit structures 231, 232, 233, 234 are open ends. There are slit lengths 2313, 2323, 2333, 2343 from the first ends 2311, 2321, 2331, 2341 to the respective second ends 2312, 2322, 2332, 2342 of the slit structures 231, 232, 233, 234, respectively. The distance of the slit lengths 2313, 2323, 2333, 2343 is between 0.1 wavelengths and 0.49 wavelengths of the lowest operating frequency of the first communication band 25 (as shown in FIG. 2B-1 and FIG. 2B-2, 5.925 GHz to 6.425 GHz). The distance of the first interval d1 is between 0.01 wavelengths and 0.336 wavelengths of the lowest operating frequency of the first communication band 25. The area of the second conductor layer 22 is between 0.25 wavelengths squared and 0.99 wavelengths squared of the lowest operating frequency of the first communication band 25. The area of the center slot structure 221 is between 0.01 times and 0.39 times the area of the second conductor layer 22. The center slot structure 221 has a first grounding conductor structure 26. The first grounding conductor structure 26 is electrically connecting with the first conductor layer 21. The first grounding conductor structure 26 has an electrical connection point p61 and may be electrically connecting with an electrical connection point p62 of the first conductor layer 21 via a conductor pin, a conductor column, or a conductor plate structure. The first grounding conductor structure 26 is parallel to the second conductor layer 22 and the first grounding conductor structure 26 has a square shape. The first grounding conductor structure 26 may be a square, circular, diamond, or rectangular conductor plate. The distance of each coupling interval s11, s12, s21, s22, s31, s32, s41, s42 is between 0.003 wavelengths and 0.095 wavelengths of the lowest operating frequency of the first communication band 25. The second conductor layer 22 is formed on a dielectric layer 29.

The total number of the slit structures 231, 232, 233, 234 is four, the total number of the slit structures 231, 232, 233, 234 is an even number, and the total number of the slit structures is less than or equal to 6. The signal sources 2411, 2412, 2421, 2422, 2431, 2432, 2441, 2442 are transmission lines, impedance matching circuits, amplifier circuits, feeding networks, switch circuits, connector elements, filter circuits, integrated circuit chips, or RF front-end modules. In practical applications, the multi-feed antenna 2 may be manufactured and assembled using, but not limited to, a circuit board process, a conductor cutting process, a ceramic process, a plastic injection molding process, or a plastic metallization process. The multi-feed antenna 2 may be configured as a single set or configured as multiple sets and applied to a multi-input multi-output antenna system, a pattern switching antenna system, or a beam-forming antenna system, or electrically connected via a transmission line or a radio-frequency feeding network to improve radiating gain.

FIG. 2A is the multi-feed antenna 2 of an embodiment of the disclosure, although the total number of the slit structures 231, 232, 233, 234, the total number of the radiating conductor plates 241, 242, 243, 244, and the total number of the signal sources 2411, 2412, 2421, 2422, 2431, 2432, 2441, 2442 are all twice that of the multi-feed antenna 1 of an embodiment. In addition, the second ends 2312, 2322, 2332, 2342 of the plurality of slit structures 231, 232, 233, 234 of the multi-feed antenna 2 are all open ends. In particular, the center slot structure 221 has a first grounding conductor structure 26. Moreover, there are coupling intervals s11, s12, s21, s22, s31, s32, s41, s42 between the signal sources 2411, 2412, 2421, 2422, 2431, 2432, 2441, 2442 thereof and different radiating conductor plates 241, 242, 243, 244, respectively. Therefore, the structures of the multi-feed antenna 2 and the multi-feed antenna 1 of an embodiment are not completely identical. However, the multi-feed antenna 2 is also designed such that the second conductor layer 22 has the center slot structure 221 to effectively achieve good isolation between the eight signal sources 2411, 2412, 2421, 2422 and 2431, 2432, 2441, 2442 (as shown in FIG. 2C-1 and FIG. 2C-2) to increase the radiation efficiency of the excited resonant modes 24111, 24121, 24211, 24221 (as shown in FIG. 2B-1) and 24311, 24321, 24411, 24421 (as shown in FIG. 2B-2) in the covered first communication band 25 (as shown in FIG. 2D-1 and FIG. 2D-2). The multi-feed antenna 2 is also designed such that the plurality of slit structures 231, 232, 233, 234 are all formed at the second conductor layer 22, the plurality of slit structures 231, 232, 233, 234 each have first ends 2311, 2321, 2331, 2341 connecting with the center slot structure 221, and each have second ends 2312, 2322, 2332, 2342 respectively extending to different side edges 2211, 2212, 2213, 2214 of the second conductor layer 22. Therefore, good impedance matching between the four radiating conductor plates 241, 242, 243, 244 and the eight signal sources 2411, 2412, 2421, 2422 and 2431, 2432, 2441, 2442 could also be effectively improved (as shown in FIG. 2B-1 and FIG. 2B-2). Furthermore, by designing the distance of the slit lengths 2313, 2323, 2333, 2343 to be between 0.1 wavelengths and 0.49 wavelengths of the lowest operating frequency of the first communication band 25 (as shown in FIG. 2B-1 and FIG. 2B-2, 5.925 GHz to 6.425 GHz), the distance of the first interval d1 is between 0.01 wavelengths and 0.336 wavelengths of the lowest operating frequency of the first communication band 25, the area of the second conductor layer 22 is between 0.25 wavelengths squared and 0.99 wavelengths squared of the lowest operating frequency of the first communication band 25, and the area of the center slot structure 221 is designed to be between 0.01 times and 0.39 times the area of the second conductor layer 22 to effectively optimize the structural dimensions of the multi-feed antenna 2 conjoined integration and increase the operating bandwidths of the resonant modes 24111, 24121, 24211, 24221 and 24311, 24321, 24411, 244211 excited by the eight signal sources 2411, 2412, 2421, 2422 and 2431, 2432, 2441, 2442 at the same time (as shown in FIG. 2B-1 and FIG. 2B-2). Therefore, similar to the multi-feed antenna 1, the multi-feed antenna 2 of an embodiment of the disclosure could also successfully achieve the technical effects of multi-antenna compatible conjoined integration, broadband operation, and good radiation efficiency.

FIG. 2B-1 and FIG. 2B-2 show return loss curve diagrams of the multi-feed antenna 2 of an embodiment of the disclosure. The following sizes are selected for the experiment: the first interval d1 is approximately 1.5 mm; the distances of the slit lengths 2313, 2323, 2333, 2343 are all respectively approximately 12.1 mm; the distances of the coupling intervals s11, s12, s21, s22, s31, s32, s41, s42 are approximately 0.5 mm; the area of the second conductor layer 22 is approximately 1296 mm²; and the area of the center slot structure 221 is approximately 109.3 mm² . As shown in FIG. 2B-1 and FIG. 2B-2, the eight signal sources 2411, 2412, 2421, 2422 and 2431, 2432, 2441, 2442 could all effectively excite the second conductor layer 22 to respectively generate at least one well-matched resonant mode 24111, 24121, 24211, 24221 and 24311, 24321, 24411, 24421 (as shown in FIG. 2B-1 and FIG. 2B-2), and cover at least one identical first communication band 25 (as shown in FIG. 2B-1 and FIG. 2B-2, 5.925 GHz to 6.425 GHz). In the present embodiment, the frequency band range of the first communication band 25 is 5.925 GHz to 6.425 GHz, and the lowest operating frequency of the first communication band 25 is 5.925 GHz. FIG. 2C-1 and FIG. 2C-2 show isolation curve diagrams of the multi-feed antenna 2 of an embodiment of the disclosure. The isolation curve between the signal source 2411 and the signal source 2412 is 241112, the isolation curve between the signal source 2412 and the signal source 2421 is 241221, the isolation curve between the signal source 2421 and the signal source 2422 is 242122, and the isolation curve between the signal source 2422 and the signal source 2431 is 242231. The isolation curve between the signal source 2431 and the signal source 2432 is 243132, the isolation curve between the signal source 2432 and the signal source 2441 is 243241, the isolation curve between the signal source 2441 and the signal source 2442 is 244142, and the isolation curve between the signal source 2442 and the signal source 2411 is 244211. As shown in FIG. 2C-1 and FIG. 2C-2, good isolation could be achieved between all of the eight signal sources 2411, 2412, 2421, 2422, and 2431, 2432, 2441, 2442 of the multi-feed antenna 2. FIG. 2D-1 and FIG. 2D-2 show a graph of the radiation efficiency of the multi-feed antenna 2. The radiation efficiency curve of the signal source 2411 is 24112, the radiation efficiency curve of the signal source 2412 is 24122, the radiation efficiency curve of the signal source 2421 is 24212, and the radiation efficiency curve of the signal source 2422 is 24222. The radiation efficiency curve of the signal source 2431 is 24312, the radiation efficiency curve of the signal source 2432 is 24322, the radiation efficiency curve of the signal source 2441 is 24412, and the radiation efficiency curve of the signal source 2442 is 24422. As shown in FIG. 2D-1 and FIG. 2D-2, the eight signal sources 2411, 2412, 2421, 2422 and 2431, 2432, 2441, 2442 could all achieve good radiation efficiency characteristics within the operating frequency band of the first communication band 25.

The communication band operations and the experimental data covered in FIG. 2B-1, FIG. 2B-2, FIG. 2C-1, FIG. 2C-2, FIG. 2D-1, FIG. 2D-2 are for experimentally proving the technical efficacy of the multi-feed antenna 2 of an embodiment of the disclosure in FIG. 2A and are not intended to limit the communication band operations, the applications, and the specifications that may be covered by the practical application of the multi-feed antenna 2 of the disclosure. The multi-feed antenna 2 may be configured as a single set or configured as multiple sets and applied to a multi-input multi-output antenna system, a pattern switching antenna system, or a beam-forming antenna system, or electrically connected with a transmission line or a radio-frequency feeding network to improve radiation gain.

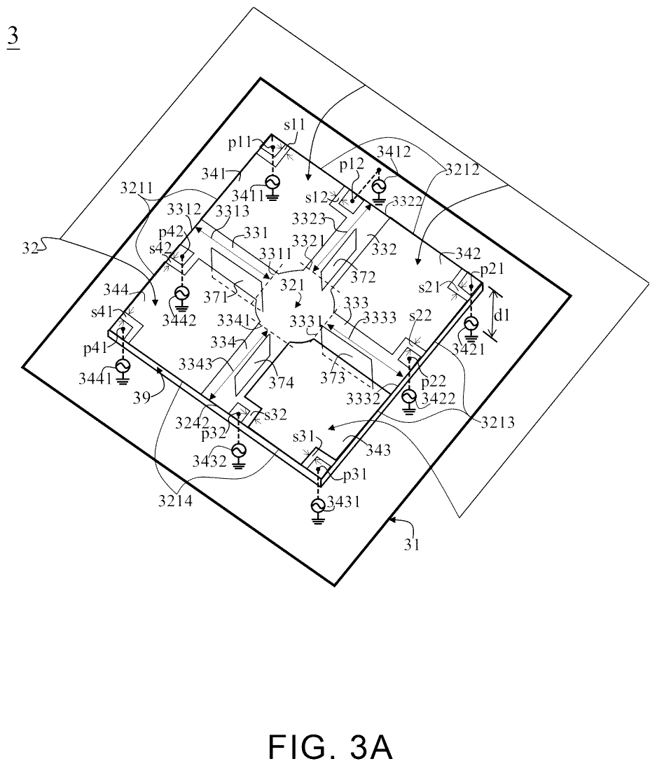

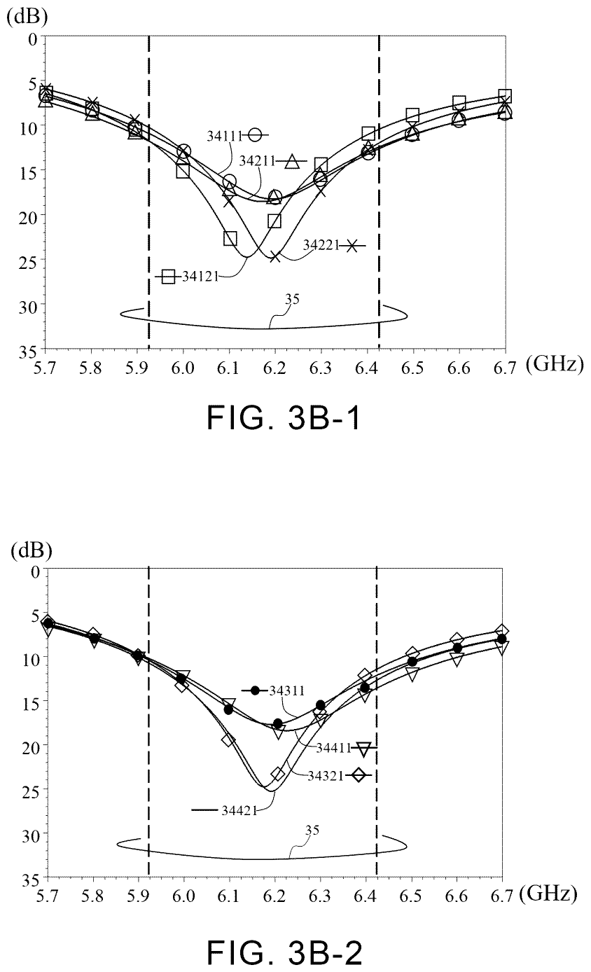

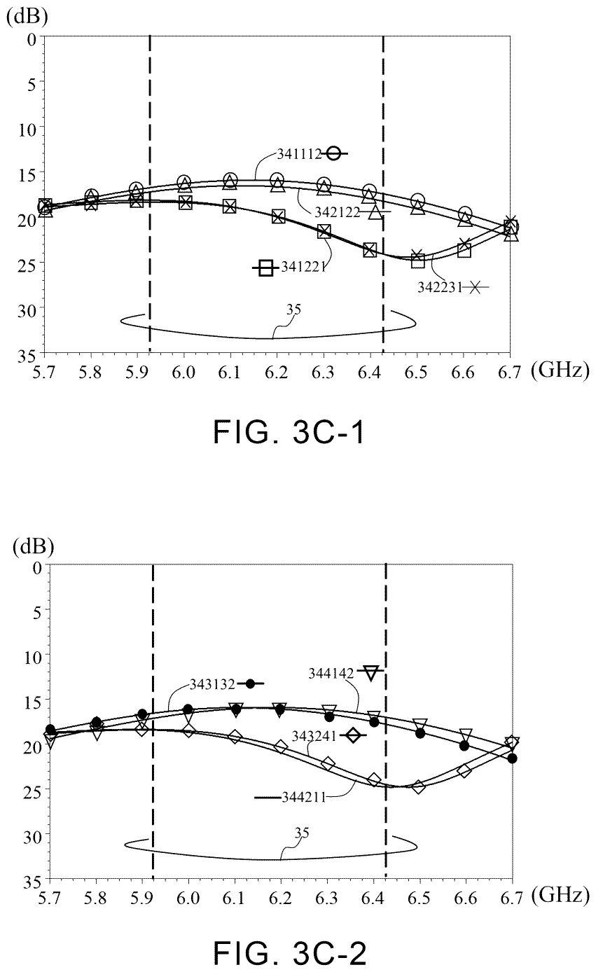

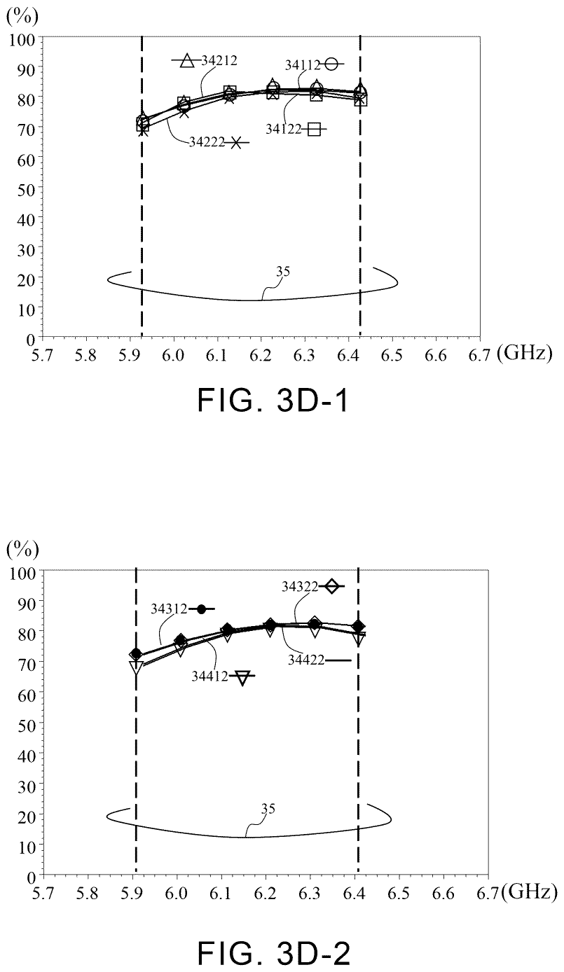

FIG. 3A is a structural diagram of a multi-feed antenna 3 of an embodiment of the disclosure. As shown in FIG. 3A, the multi-feed antenna 3 includes a first conductor layer 31, a second conductor layer 32, and a plurality of slit structures 331, 332, 333, 334. There is the first interval d1 between the second conductor layer 32 and the first conductor layer 31. The second conductor layer 32 has a center slot structure 321. The plurality of slit structures 331, 332, 333, 334 are all formed at the second conductor layer 32, wherein each has first ends 3311, 3321, 3331, 3341 connecting with the center slot structure 321, and each has second ends 3312, 3322, 3332, 3342 respectively extending to different side edges 3211, 3212, 3213, 3214 of the second conductor layer 32. The plurality of slit structures 331, 332, 333, 334 make the second conductor layer 32 form a plurality of radiating conductor plates 341, 342, 343, 344. The total number of the slit structures 331, 332, 333, 334 equals to the total number of the radiating conductor plates 341, 342, 343, 344, which is four. Each of the radiating conductor plates 341, 342, 343, 344 is electrically coupled to two signal sources 3411 and 3412, 3421 and 3422, 3431 and 3432, 3441 and 3442. There are coupling intervals s11 and s12 and electrical connection points p11 and p12 between the signal sources 3411 and 3412 and the radiating conductor plate 341, respectively. There are coupling intervals s21 and s22 and electrical connection points p21 and p22 between the signal sources 3421 and 3422 and the radiating conductor plate 342, respectively. There are coupling intervals s31 and s32 and electrical connection points p31 and p32 between the signal sources 3431 and 3432 and the radiating conductor plate 343, respectively. There are coupling intervals s41 and s42 and electrical connection points p41 and p42 between the signal sources 3441 and 3442 and the radiating conductor plate 344, respectively. In particular, for the radiating conductor plate 341 and the radiating conductor plate 342 adjacent to the identical slit structure 332, if the connecting line of the feeding electrical connection points p11 and p12 of the radiating conductor plate 341 and the connecting line of the feeding electrical connection points p21 and p22 of the radiating conductor plate 342 are intersected, the included angle formed by the intersection of the connecting line of the electrical connection points p11 and p12 and the connecting line of the electrical connection points p21 and p22 is between 60 degrees and 120 degrees. Similarly, for the radiating conductor plate 342 and the radiating conductor plate 343 adjacent to the identical slit structure 333, if the connecting line of the feeding electrical connection points p21 and p22 of the radiating conductor plate 342 and the connecting line of the feeding electrical connection points p31 and p32 of the radiating conductor plate 343 are intersected, the included angle formed by the intersection of the connecting line of the electrical connection points p21 and p22 and the connecting line of the electrical connection points p31 and p32 is between 60 degrees and 120 degrees. For the radiating conductor plate 343 and the radiating conductor plate 344 adjacent to the identical slit structure 334, if the connecting line of the feeding electrical connection points p31 and p32 of the radiating conductor plate 343 and the connecting line of the feeding electrical connection points p41 and p42 of the radiating conductor plate 344 are intersected, the included angle formed by the intersection of the connecting line of the electrical connection points p31 and p32 and the connecting line of the electrical connection points p41 and p42 is between 60 degrees and 120 degrees. For the radiating conductor plate 344 and the radiating conductor plate 341 adjacent to the identical slit structure 331, if the connecting line of the feeding electrical connection points p41 and p42 of the radiating conductor plate 344 and the connecting line of the feeding electrical connection points p11 and p12 of the radiating conductor plate 341 are intersected, the included angle formed by the intersection of the connecting line of the electrical connection points p41 and p42 and the connecting line of the electrical connection points p11 and p12 is between 60 degrees and 120 degrees. Each of the signal sources 3411, 3412, 3421, 3422 and 3431, 3432, 3441, 3442 respectively excites the second conductor layer 32 to generate at least one resonant mode 34111, 34121, 34211, 34221 (as shown in FIG. 3B-1) and 34311, 34321, 34411, 34421 (as shown in FIG. 3B-2). The plurality of resonant modes 34111, 34121, 34211, 34221 and 34311, 34321, 34411, 34421 cover at least one identical first communication band 35 (as shown in FIG. 3B-1 and FIG. 3B-2).

In particular, each of the radiating conductor plates 341, 342, 343, 344 is electrically coupled to two signal sources 3411 and 3412, 3421 and 3422, 3431 and 3432, 3441 and 3442, respectively. The second ends 3312, 3322, 3332, 3342 of the plurality of slit structures 331, 332, 333, 334 are open ends. There are slit lengths 3313, 3323, 3333, 3343 from the first ends 3311, 3321, 3331, 3341 to the respective second ends 3312, 3322, 3332, 3342 of the slit structures 331, 332, 333, 334, respectively. The distance of the slit lengths 3313, 3323, 3333, 3343 is between 0.1 wavelengths and 0.49 wavelengths of the lowest operating frequency of the first communication band 35 (as shown in FIG. 3B-1 and FIG. 3B-2, 5.925 GHz to 6.425 GHz). The distance of the first interval d1 is between 0.01 wavelengths and 0.336 wavelengths of the lowest operating frequency of the first communication band 35. The area of the second conductor layer 32 is between 0.25 wavelengths squared and 0.99 wavelengths squared of the lowest operating frequency of the first communication band 35. The area of the center slot structure 321 is between 0.01 times and 0.39 times the area of the second conductor layer 32. The slit structures 331, 332, 333, 334 all have a second grounding conductor structures 371, 372, 373, 374. The second grounding conductor structures 371, 372, 373, 374 are all electrically connecting with the first conductor layer 31. The second grounding conductor structures 371, 372, 373, 374 are all perpendicular to the first conductor layer 31, and the second grounding conductor structures 371, 372, 373, 374 are rectangular conductor plates. The second grounding conductor structures 371, 372, 373, 374 may be rectangular or square conductor plates or a plurality of conductor columns. The distance of each coupling interval s11, s12, s21, s22, s31, s32, s41, s42 is between 0.003 wavelengths and 0.095 wavelengths of the lowest operating frequency of the first communication band 35. The second conductor layer 32 is formed on a dielectric layer 39. The total number of the slit structures 331, 332, 333, 334 is four, the total number of the slit structures 331, 332, 333, 334 is an even number, and the total number of the slit structures is less than or equal to 6. The signal sources 3411, 3412, 3421, 3422, 3431, 3432, 3441, 3442 are transmission lines, impedance matching circuits, amplifier circuits, feeding networks, switch circuits, connector elements, filter circuits, integrated circuit chips, or RF front-end modules. In practical applications, the multi-feed antenna 3 may be manufactured and assembled using, but not limited to, a circuit board process, a conductor cutting process, a ceramic process, a plastic injection molding process, or a plastic metallization process. The multi-feed antenna 3 may be configured as a single set or configured as multiple sets and applied to a multi-input multi-output antenna system, a pattern switching antenna system, or a beam-forming antenna system, or electrically connected with a transmission line or a radio-frequency feeding network to improve radiation gain.

FIG. 3A is the multi-feed antenna 3 of an embodiment of the disclosure, although the total number of the slit structures 331, 332, 333, 334, the total number of the radiating conductor plates 341, 342, 343, 344, and the total number of the signal sources 3411, 3412, 3421, 3422, 3431, 3432, 3441, 3442 are all twice that of the multi-feed antenna 1 of an embodiment. In addition, the second ends 3312, 3322, 3332, 3342 of the plurality of slit structures 331, 332, 333, 334 of the multi-feed antenna 3 are all open ends. The slit structures 331, 332, 333, 334 all each have a second grounding conductor structure 371, 372, 373, 374. Moreover, there are coupling intervals s11, s12, s21, s22, s31, s32, s41, s42 between the signal sources 3411, 3412, 3421, 3422, 3431, 3432, 3441, 3442 thereof and different radiating conductor plates 341, 342, 343, 344, respectively. Therefore, the structures of the multi-feed antenna 3 and the multi-feed antenna 1 of an embodiment are not completely identical. However, the multi-feed antenna 3 is also designed such that the second conductor layer 32 has the center slot structure 321 to effectively achieve good isolation between the eight signal sources 3411, 3412, 3421, 3422 and 3431, 3432, 3441, 3442 (as shown in FIG. 3C-1 and FIG. 3C-2) to increase the radiation efficiency of the excited resonant modes 34111, 34121, 34211, 34221 (as shown in FIG. 3B-1) and 34311, 34321, 34411, 34421 (as shown in FIG. 3B-2) in the covered first communication band 35 (as shown in FIG. 3D-1 and FIG. 3D-2). The multi-feed antenna 3 is also designed such that a plurality of slit structures 331, 332, 333, 334 are all formed at the second conductor layer 32, the plurality of slit structures 331, 332, 333, 334 each have first ends 3311, 3321, 3331, 3341 connecting with the center slot structure 321, and each have second ends 3312, 3322, 3332, 3342 respectively extending to different side edges 3211, 3212, 3213, 3214 of the second conductor layer 32. Therefore, good impedance matching between the four radiating conductor plates 341, 342, 343, 344 and the eight signal sources 3411, 3412, 3421, 3422 and 3431, 3432, 3441, 3442 could also be effectively improved (as shown in FIG. 3B-1 and FIG. 3B-2). Furthermore, by designing the distance of the slit lengths 3313, 3323, 3333, 3343 to be between 0.1 wavelengths and 0.49 wavelengths of the lowest operating frequency of the first communication band 35 (as shown in FIG. 3B-1 and FIG. 3B-2, 5.925 GHz to 6.425 GHz), the distance of the first interval d1 is between 0.01 wavelengths and 0.336 wavelengths of the lowest operating frequency of the first communication band 35, the area of the second conductor layer 32 is between 0.25 wavelengths squared and 0.99 wavelengths squared of the lowest operating frequency of the first communication band 35, and the area of the center slot structure 321 is designed to be between 0.01 times and 0.39 times the area of the second conductor layer 32 to effectively optimize the structural dimensions of the multi-feed antenna 3 conjoined integration and increase the operating bandwidths of the resonant modes 34111, 34121, 34211, 34221 and 34311, 34321, 34411, 34421 excited by the eight signal sources 3411, 3412, 3421, 3422 and 3431, 3432, 3441, 3442 at the same time (as shown in FIG. 3B-1 and FIG. 3B-2). Therefore, similar to the multi-feed antenna 1, the multi-feed antenna 3 of an embodiment of the disclosure could also successfully achieve the technical effects of multi-antenna compatible conjoined integration, broadband operation, and good radiation efficiency.

FIG. 3B-1 and FIG. 3B-2 show return loss curve diagrams of the multi-feed antenna 3 of an embodiment of the disclosure. The following sizes are selected for the experiment: the first interval d1 is approximately 5 mm; the distances of the slit lengths 3313, 3323, 3333, 3343 are all respectively approximately 15.3 mm; the distances of the coupling intervals s11, s12, s21, s22, s31, s32, s41, s42 are approximately 0.7 mm; the area of the second conductor layer 32 is approximately 1369 mm²; and the area of the center slot structure 321 is approximately 73.9 mm² . As shown in FIG. 3B-1 and FIG. 3B-2, the eight signal sources 3411, 3412, 3421, 3422 and 3431, 3432, 3441, 3442 could all effectively excite the second conductor layer 32 to respectively generate at least one well-matched resonant mode 34111, 34121, 34211, 34221 and 34311, 34321, 34411, 34421 (as shown in FIG. 3B-1 and FIG. 3B-2), and cover at least one identical first communication band 35 (as shown in FIG. 3B-1 and FIG. 3B-2, 5.925 GHz to 6.425 GHz). In the present embodiment, the frequency band range of the first communication band 35 is 5.925 GHz to 6.425 GHz, and the lowest operating frequency of the first communication band 35 is 5.925 GHz. FIG. 3C-1 and FIG. 3C-2 show isolation curve diagrams of the multi-feed antenna 3 of an embodiment of the disclosure. The isolation curve between the signal source 3411 and the signal source 3412 is 341112, the isolation curve between the signal source 3412 and the signal source 3421 is 341221, the isolation curve between the signal source 3421 and the signal source 3422 is 342122, and the isolation curve between the signal source 3422 and the signal source 3431 is 342231. The isolation curve between the signal source 3431 and the signal source 3432 is 343132, the isolation curve between the signal source 3432 and the signal source 3441 is 343241, the isolation curve between the signal source 3441 and the signal source 3442 is 344142, and the isolation curve between the signal source 3442 and the signal source 3411 is 344211. As shown in FIG. 3C-1 and FIG. 3C-2, good isolation could be achieved between all of the eight signal sources 3411, 3412, 3421, 3422, and 3431, 3432, 3441, 3442 of the multi-feed antenna 3. FIG. 3D-1 and FIG. 3D-2 show a graph of the radiation efficiency of the multi-feed antenna 3. The radiation efficiency curve of the signal source 3411 is 34112, the radiation efficiency curve of the signal source 3412 is 34122, the radiation efficiency curve of the signal source 3421 is 34212, and the radiation efficiency curve of the signal source 3422 is 34222. The radiation efficiency curve of the signal source 3431 is 34312, the radiation efficiency curve of the signal source 3432 is 34322, the radiation efficiency curve of the signal source 3441 is 34412, and the radiation efficiency curve of the signal source 3442 is 34422. As shown in FIG. 3D-1 and FIG. 3D-2, the eight signal sources 3411, 3412, 3421, 3422 and 3431, 3432, 3441, 3442 could all achieve good radiation efficiency characteristics within the operating frequency band of the first communication band 35.

The communication band operations and the experimental data covered in FIG. 3B-1, FIG. 3B-2, FIG. 3C-1, FIG. 3C-2, FIG. 3D-1, FIG. 3D-2 are for experimentally proving the technical efficacy of the multi-feed antenna 3 of an embodiment of the disclosure in FIG. 3A and are not intended to limit the communication band operations, the applications, and the specifications that may be covered by the actual application of the multi-feed antenna 3 of the disclosure. The multi-feed antenna 3 may be configured as a single set or configured as multiple sets and applied to a multi-input multi-output antenna system, a field-switching antenna system, or a beam-forming antenna system, or electrically connected with a transmission line or a radio-frequency feeding network to improve radiation gain.

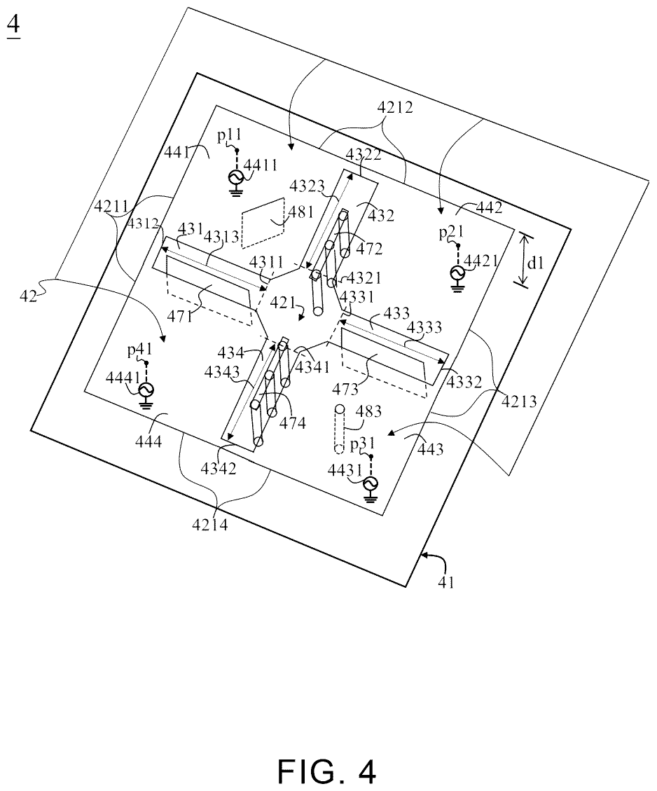

FIG. 4 is a structural diagram of a multi-feed antenna 4 of an embodiment of the disclosure. As shown in FIG. 4, the multi-feed antenna 4 includes a first conductor layer 41, a second conductor layer 42, and a plurality of slit structures 431, 432, 433, 434. There is a first interval d1 between the second conductor layer 42 and the first conductor layer 41. The second conductor layer 42 has a center slot structure 421. The plurality of slit structures 431, 432, 433, 434 are all formed at the second conductor layer 42, wherein each has first ends 4311, 4321, 4331, 4341 connecting with the center slot structure 421, and each has second ends 4312, 4322, 4332, 4342 respectively extending to different side edges 4211, 4212, 4213, 4214 of the second conductor layer 42. The plurality of slit structures 431, 432, 433, 434 make the second conductor layer 42 form a plurality of radiating conductor plates 441, 442, 443, 444. The total number of the slit structures 431, 432, 433, 434 equals to the total number of the radiating conductor plates 441, 442, 443, 444, which is four. Each of the radiating conductor plates 441, 442, 443, 444 is electrically connecting with at least one signal source 4411, 4421, 4431, 4441, respectively. There is the electrical connection point p11 between the signal source 4411 and the radiating conductor plate 441. There is the electrical connection point p21 between the signal source 4421 and the radiating conductor plate 442. There is the electrical connection point p31 between the signal source 4431 and the radiating conductor plate 443. There is the electrical connection point p41 between the signal source 4441 and the radiating conductor plate 444. Each of the signal sources 4411, 4421, 4431, 4441 excites the second conductor layer 42 to generate at least one resonant mode, respectively. The plurality of resonant modes cover at least one identical first communication band.

In particular, the second ends 4312, 4322, 4332, 4342 of the plurality of slit structures 431, 432, 433, 434 are closed ends. There are slit lengths 4313, 4323, 4333, 4343 from the first ends 4311, 4321, 4331, 4341 to the respective second ends 4312, 4322, 4332, 4342 of the slit structures 431, 432, 433, 434, respectively. The distance of the slit lengths 4313, 4323, 4333, 4343 is between 0.1 wavelengths and 0.49 wavelengths of the lowest operating frequency of the first communication band. The distance of the first interval d1 is between 0.01 wavelengths and 0.336 wavelengths of the lowest operating frequency of the first communication band. The area of the second conductor layer 42 is between 0.25 wavelengths squared and 0.99 wavelengths squared of the lowest operating frequency of the first communication band. The area of the center slot structure 421 is between 0.01 times and 0.39 times the area of the second conductor layer 42. The radiating conductor plate 441 is electrically connecting with a third grounding conductor structure 481, and the third grounding conductor structure 481 is a conductor plate. The radiating conductor plate 443 is electrically connecting with a third grounding conductor structure 483, and the third grounding conductor structure 483 is a conductor pin and may also be a plurality of conductor column structures. One end of the third grounding conductor structures 481 and 483 is electrically connecting with the radiating conductor plates 441 and 443 respectively, and another end thereof is electrically connecting with the first conductor layer 41. The third grounding conductor structures 481 and 483 may be conductor pins, conductor plates, or a plurality of conductor column structures, and are formed between the first conductor layer 41 and the second conductor layer 42. The total number of the slit structures 431, 432, 433, 434 is four, the total number of the slit structures 431, 432, 433, 434 is an even number, and the total number of the slit structures is less than or equal to 6. The slit structures 431, 432, 433, 434 all have a second grounding conductor structures 471, 472, 473, 474. The second grounding conductor structures 471, 472, 473, 474 are all electrically connecting with the first conductor layer 41. The second grounding conductor structures 471, 472, 473, 474 are all perpendicular to the first conductor layer 41. The second grounding conductor structures 471 and 473 are rectangular conductor plates. The second grounding conductor structures 472 and 474 are a plurality of conductor column structures. The signal sources 4411, 4421, 4431, 4441 are transmission lines, impedance matching circuits, amplifier circuits, feeding networks, switch circuits, connector elements, filter circuits, integrated circuit chips, or RF front-end modules. In practical applications, the multi-feed antenna 4 may be manufactured and assembled using, but not limited to, a circuit board process, a conductor cutting process, a ceramic process, a plastic injection molding process, or a plastic metallization process. The multi-feed antenna 4 may be configured as a single set or configured as multiple sets and applied to a multi-input multi-output antenna system, a pattern switching antenna system, or a beam-forming antenna system, or electrically connected via a transmission line or a radio-frequency feeding network to improve radiating gain.

FIG. 4 is the multi-feed antenna 4 of an embodiment of the disclosure, although the total number of the slit structures 431, 432, 433, 434 and the total number of the radiating conductor plates 441, 442, 443, 444 thereof are both twice that of the multi-feed antenna 1 of an embodiment. In addition, the second ends 4312, 4322, 4332, 4342 of the plurality of slit structures 431, 432, 433, 434 of the multi-feed antenna 4 are all closed ends. Each of the radiating conductor plates 441, 442, 443, 444 is electrically connecting with at least one signal source 4411, 4421, 4431, 4441, respectively. The radiating conductor plate 441 is electrically connecting with a third grounding conductor structure 481, and the radiating conductor plate 443 is electrically connecting with a third grounding conductor structure 483. The slit structures 431, 432, 433, 434 all each have a second grounding conductor structure 471, 472, 473, 474. Therefore, the structures of the multi-feed antenna 4 and the multi-feed antenna 1 of an embodiment are not completely identical. However, the multi-feed antenna 4 is also designed such that the second conductor layer 42 has a center slot structure 421 to effectively improve the energy isolation between the four signal sources 4411, 4421, 4431, 4441 to increase the radiation efficiency of the excited resonant mode in the covered first communication band. The multi-feed antenna 4 is also designed such that a plurality of slit structures 431, 432, 433, 434 are all formed at the second conductor layer 42, the plurality of slit structures 431, 432, 433, 434 each have first ends 4311, 4321, 4331, 4341 connecting with the center slot structure 421, and each have second ends 4312, 4322, 4332, 4342 respectively extending to different side edges 4211, 4212, 4213, 4214 of the second conductor layer 42. Therefore, the impedance matching between the four radiating conductor plates 441, 442, 443, 444 and the four signal sources 4411, 4421, 4431, 4441 could also be effectively improved. Furthermore, by designing the distance of the slit lengths 4313, 4323, 4333, 4343 to be between 0.1 wavelengths and 0.49 wavelengths of the lowest operating frequency of the first communication band, the distance of the first interval d1 is between 0.01 wavelengths and 0.336 wavelengths of the lowest operating frequency of the first communication band 35, the area of the second conductor layer 42 is between 0.25 wavelengths squared and 0.99 wavelengths squared of the lowest operating frequency of the first communication band, and the area of the center slot structure 421 is designed to be between 0.01 times and 0.39 times the area of the second conductor layer 42 to effectively optimize the structural dimensions of the multi-feed antenna 4 conjoined integration and increase the operating bandwidths of the resonant modes excited by the four signal sources 4411, 4421, 4431, 4441 at the same time. Therefore, similar to the multi-feed antenna 1, the multi-feed antenna 4 of an embodiment of the disclosure could also successfully achieve the technical effects of multi-antenna compatible conjoined integration, broadband operation, and good radiation efficiency. The multi-feed antenna 4 also could be configured as a single set or configured as multiple sets and applied to a multi-input multi-output antenna system, a pattern switching antenna system, or a beam-forming antenna system, or electrically connected with a transmission line or a radio-frequency feeding network to improve radiating gain.

Based on the above, although the disclosure has been disclosed as above by way of embodiments, they are not intended to limit the disclosure. Those having ordinary skill in the art may make various modifications and alterations without departing from the spirit and scope of the disclosure. Therefore, the scope of the present application should be defined by the scope of the appended claims.

What is claimed is:

1. A multi-feed antenna, comprising:
a first conductor layer;
a second conductor layer, wherein the second conductor layer is spaced apart from the first conductor layer at a first interval, and the second conductor layer has a center slot structure; and
a plurality of slit structures all formed at the second conductor layer, wherein each of the plurality of slit structures has a first end connecting with the center slot structure, and each of the plurality of slit structures has a second end respectively extending to different side edges of the second conductor layer, the plurality of slit structures make the second conductor layer form a plurality of radiating conductor plates, a total number of the slit structures equals to a total number of the radiating conductor plates, each of the radiating conductor plates is electrically connected or electrically coupled to at least one signal source, each of the signal sources respectively excites the second conductor layer to generate at least one resonant mode, and the plurality of resonant modes cover at least one identical first communication band.

2. The multi-feed antenna of claim 1, wherein each of the radiating conductor plates is electrically connecting with two signal sources.

3. The multi-feed antenna of claim 1, wherein the second end of the slit structure is an open end.

4. The multi-feed antenna of claim 1, wherein the second end of the slit structures is a closed end.

5. The multi-feed antenna of claim 1, wherein there is a slit length from the first end to the second end of the slit structures, and a distance of the slit length is between 0.1 wavelengths and 0.49 wavelengths of a lowest operating frequency of the first communication band.

6. The multi-feed antenna of claim 1, wherein the center slot structure has a first grounding conductor structure, and the first grounding conductor structure is electrically connecting with the first conductor layer.

7. The multi-feed antenna of claim 6, wherein the first grounding conductor structure is parallel to the second conductor layer, and the first grounding conductor structure is a square, circular, diamond, or rectangular conductor plate.

8. The multi-feed antenna of claim 1, wherein the slit structure has a second grounding conductor structure therein, and the second grounding conductor structure is electrically connecting with the first conductor layer.

9. The multi-feed antenna of claim 8, wherein the second grounding conductor structure is perpendicular to the first conductor layer, and the second grounding conductor structure is a rectangular or square conductor plate or a plurality of conductor columns.

10. The multi-feed antenna of claim 1, wherein the signal source is spaced apart from the radiating conductor plate at a coupling interval.

11. The multi-feed antenna of claim 10, wherein a distance of the coupling interval is between 0.003 wavelengths and 0.095 wavelengths of a lowest operating frequency of the first communication band.

12. The multi-feed antenna of claim 1, wherein a distance of the first interval is between 0.01 wavelengths and 0.336 wavelengths of a lowest operating frequency of the first communication band.

13. The multi-feed antenna of claim 1, wherein an area of the second conductor layer is between 0.25 wavelengths squared and 0.99 wavelengths squared of a lowest operating frequency of the first communication band.

14. The multi-feed antenna of claim 1, wherein an area of the center slot structures is between 0.01 times and 0.39 times an area of the second conductor layer.

15. The multi-feed antenna of claim 1, wherein the total number of the slit structures is an even number, and the total number of the slit structures is less than or equal to 6.

16. The multi-feed antenna of claim 1, wherein the radiating conductor plates have a third grounding conductor structure.

17. The multi-feed antenna of claim 16, wherein one end of the third grounding conductor structure is electrically connecting with the radiating conductor plates, another end thereof is electrically connecting with the first conductor layer, the third grounding conductor structure may be a conductor pin, a conductor plate, or a plurality of conductor column structures, and is formed between the first conductor layer and the second conductor layer.

18. The multi-feed antenna of claim 1, wherein the second conductor layer is formed on a dielectric layer.

19. The multi-feed antenna of claim 1, wherein the signal source is a transmission line, an impedance matching circuit, an amplifier circuit, a feeding network, a switch circuit, a connector element, a filter circuit, an integrated circuit chip, or a radio-frequency front-end module.

20. The multi-feed antenna of claim 1, wherein the multi-feed antenna is configured as a single set or configured as multiple sets and applied to a multi-input multi-output antenna system, a pattern switching antenna system, or a beam-forming antenna system, or electrically connected with a transmission line or a radio-frequency feeding network to improve a radiating gain.
